(19) United States
(12) Patent Application Publication
(10) Pub. No.: US 2017/0004754 A1
(43) Pub. Date: Jan. 5, 2017

(54) DOT CORRECTION METHOD AND SYSTEM FOR LED DISPLAY DEVICE

(71) Applicant: SILICON TOUCH TECHNOLOGY INC., Hsinchu (TW)

(72) Inventors: CHI-YUAN CHIN, HSINCHU (TW); KUEI-JYUN CHEN, HSINCHU (TW)

(21) Appl. No.: 15/130,283

(22) Filed: Apr. 15, 2016

(30) Foreign Application Priority Data
Jul. 3, 2015 (TW) 104121655

(51) Int. Cl. G09G 3/20; G09G 3/32

(52) U.S. Cl. CPC G09G 3/2007; G09G 3/32; G09G 2320/0626; G09G 2360/147; G09G 2320/0233

(57) ABSTRACT

The present disclosure provides a dot correction method for a LED display device. The LED display device has a plurality of LED units arranged in an array. The method comprises providing driving currents to the plurality of LED units in columns or rows of the LED display device to make the LED units emit light; obtaining non-uniform brightness information corresponding to the LED units in columns or rows of the LED display device; and adjusting the driving current provided to each LED unit according to the non-uniform brightness information, in order to make the brightness of each LED unit be the same.

### BACKGROUND OF THE INVENTION

1. Field of the Invention

The instant disclosure relates to a light emitting diode (LED) display; in particular, to a dot correction method and a system for an LED display device.

2. Description of Related Art

A conventional method for resolving non-uniform brightness of the LEDs in a LED display device is selecting LEDs having similar brightness, or utilizing correction bits to correct the brightness of each dot. The latter method is possible by increasing the control bits of the pulse width modulation (PWM) signal.

As shown in FIG. 1A, considering the situation of dividing the brightness into 256 gray levels as an example, the brightness of the driven LED can be adjusted by pulse width modulation technology. The pulse width shown in FIG. 1B represents 1/256 of full brightness. The pulse width shown in FIG. 1C represents 3/256 of full brightness. For example, the brightness of the LED display device is originally designed to have 64 gray levels, wherein 6-bits are used. But due to the non-uniform brightness of the LEDs, additional 2-bits may be used for the purpose of brightness correction.

### SUMMARY OF THE INVENTION

The object of the instant disclosure is to provide a dot correction method and a system for an LED display device. The method and the system can correct the brightness of each dot of the LED display unit dot by dot, in order to obtain a uniform brightness.

In order to achieve the aforementioned objects, according to an embodiment of the instant disclosure, a dot correction method for an LED display device is provided. The dot correction method is used for the LED display device. The LED display device has a plurality of LED units arranged in an array. The method comprises the following steps. At first, providing driving currents to the plurality of LED units in columns or rows of the LED display device to make the LED units emit light. Then, obtaining a non-uniform brightness information corresponding to the LED units in columns or rows of the LED display device. Then, adjusting the driving current provided to each LED unit according to the non-uniform brightness information, in order to make the brightness of each LED unit be the same.

In order to achieve the aforementioned objects, according to an embodiment of the instant disclosure, a dot correction system for an LED display device is provided. The dot correction system for the LED display device comprises a brightness detection device, a brightness information generating device and an LED display device. The brightness information generating device is coupled to the brightness detection device, used for generating a non-uniform brightness information. The LED display device comprises a plurality of LED units arranged in an array, a storage unit and a driving circuit. The brightness detection device detects the brightness of the plurality of LED units. The storage unit is used for coupling to the brightness information generating device, for receiving and storing the non-uniform brightness information from the brightness information generating device. The driving circuit is coupled to the plurality of LED units and the storage unit. The driving circuit respectively drives the plurality of LED units to make the plurality of LED units emit light. The driving circuit respectively provides a driving current to each LED unit of the plurality of LED units. The driving circuit adjusts the driving current provided to each LED unit according to the non-uniform brightness information in order to make the brightness of each LED unit be the same.

In order to achieve the aforementioned objects, according to an embodiment of the instant disclosure, an LED display device is provided. The LED display comprises a plurality of LED units arranged in an array, a storage unit and a driving circuit. The storage unit is used for storing a non-uniform brightness information. The driving circuit is coupled to the plurality of LED units and the storage unit. The driving circuit respectively drives the plurality of LED units to make the plurality of LED units emit light. The driving circuit respectively provides a driving current to each LED unit of the plurality of LED units. The driving circuit adjusts the driving current provided to each LED unit according to the non-uniform brightness information in order to make the brightness of each LED unit be the same. The non-uniform brightness information is obtained by calculations of a brightness information generating device coupled to a brightness detection device after the brightness detection device detects the brightness of the plurality of LED units.

In summary, the provided dot correction method and system for an LED display device can scan the non-uniform brightness of the LEDs of each column or each row, and store the non-uniform brightness information of the LEDs in each column or each row. Then, when the LED display device is starting up, the dot correction method can adjust the driving current for the LEDs in each column or each row according to the non-uniform brightness information, without using the conventional correction bits of the control bits in the pulse width modulation signal.

In order to further the understanding regarding the instant disclosure, the following embodiments are provided along with illustrations to facilitate the disclosure of the instant disclosure.

### BRIEF DESCRIPTION OF THE DRAWINGS

FIG. 1A shows a schematic diagram of a conventional pulse width modulation (PWM) signal used for driving an LED divided into 256 equal portions;

FIG. 1B shows a schematic diagram of a conventional PWM signal for an LED generating light with 1/256 of full brightness;

FIG. 1C shows a schematic diagram of a conventional PWM signal for an LED generating light with 3/256 of full brightness;

FIG. 2 shows a schematic diagram of a plurality of LED units of an LED display device arranged in an array according to an embodiment of the instant disclosure;

FIG. 3 shows a flow chart of a dot correction method for an LED display device according to an embodiment of the instant disclosure;

FIG. 4 shows a functional block diagram of a dot correction system for an LED display device according to an embodiment of the instant disclosure; and

FIG. 5 shows a detailed flow chart of the step S120 in FIG. 3.

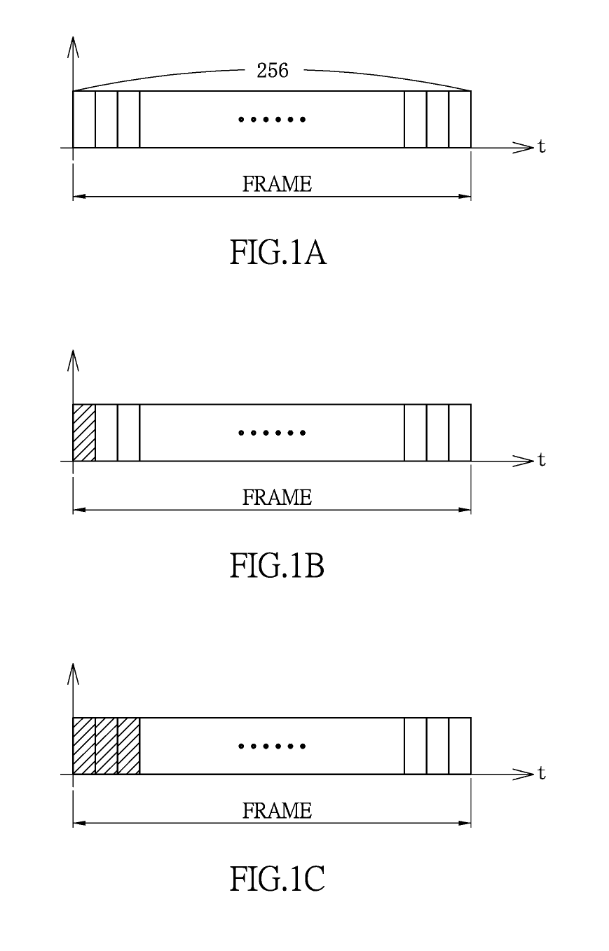

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

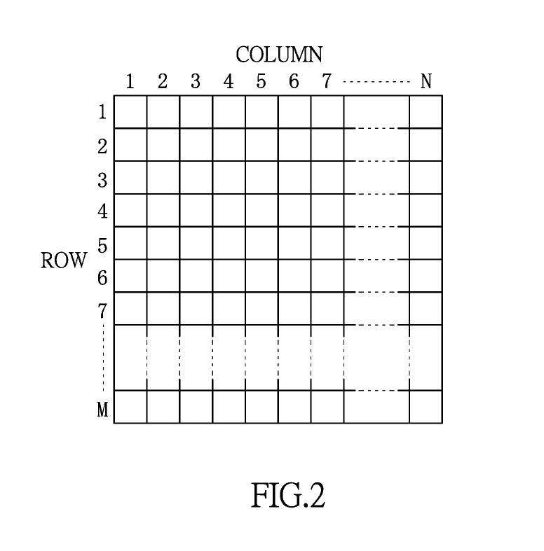

Please refer to FIG. 2 showing a schematic diagram of a plurality of LED units of a LED display device arranged in an array according to an embodiment of the instant disclosure. As shown in FIG. 2, the plurality of LED units is arranged in an M×N array. The array has M rows and N columns. That is, there are M LED units in each column, and there are N LED units in each row. When the same driving current is provided to each column or each row, the same pulse width modulation (PWM) display control signal may generate different brightness. For example, the same gray level signal may cause different LED units in the same column to generate different brightness. Or, the same gray level signal may cause different LED units in the same row to generate different brightness. This results from the manufacturing process and other related factors. Therefore, it may cause non-uniform brightness of each dot of the display.

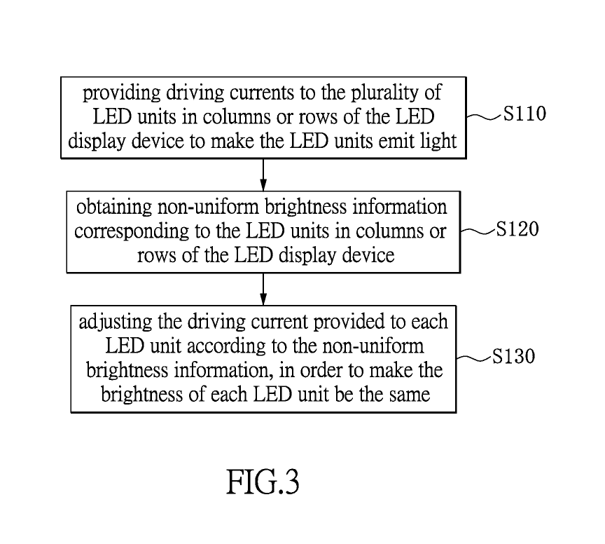

Please refer to FIG. 3 showing a flow chart of a dot correction method for an LED display device according to an embodiment of the instant disclosure. The dot correction method is used for an LED display device. The LED display device has a plurality of LED units arranged in an array (for example the array shown in FIG. 2). The method comprises the following steps. At first, in step S110, providing driving currents to the plurality of LED units in columns or rows of the LED display device to make the LED units emit light. Accordingly, each LED unit correspondingly generates a first brightness. Due to factors in the manufacturing process, the first brightness generated by each LED unit in this step may be different. Then, in step S120, obtaining a non-uniform brightness information corresponding to the LED units in columns or rows of the LED display device. Then, in step S130, adjusting the driving current provided to each LED unit according to the non-uniform brightness information, in order to make the brightness of each LED unit be the same.

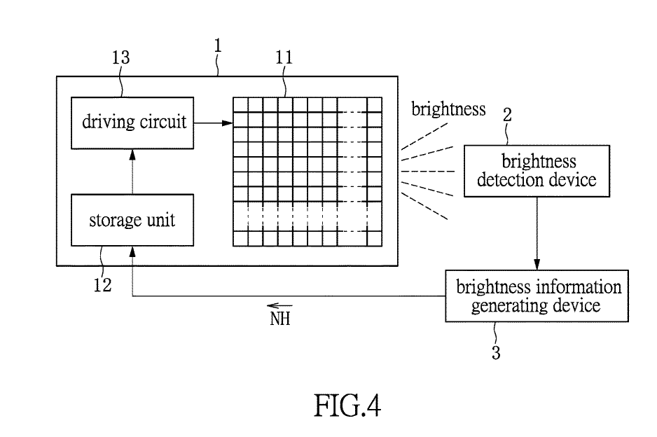

Please refer to FIG. 3 in conjunction with FIG. 4. FIG. 4 shows a functional block diagram of a dot correction system for an LED display device according to an embodiment of the instant disclosure. A dot correction system of an LED display device shown in FIG. 4 can be used in order to achieve the process of FIG. 3. The dot correction system for the LED display device comprises a brightness detection device 2, a brightness information generating device 3 and an LED display device 1.

The brightness information generating device 3 is coupled to the brightness detection device 2. The LED display device 1 comprises a plurality of LED units 11 arranged in an array, a storage unit 12 and a driving circuit 13. The brightness detection device 2 detects the brightness of the plurality of LED units 11 arranged in an array. The brightness detection device 2 has a light sensor element, for receiving the light generated by the LED. The detection conditions (comprising all external factors such as the detection distance or ambient light) of the brightness detection device 2 detecting each LED under test are the same. This instant disclosure does not limit the implementation manner of the brightness detection device 2. In order to detect the brightness of the LED, an artisan of ordinary skill in the art will appreciate how to implement the light sensor element and corresponding detection circuit, thus there is no need to go into details.

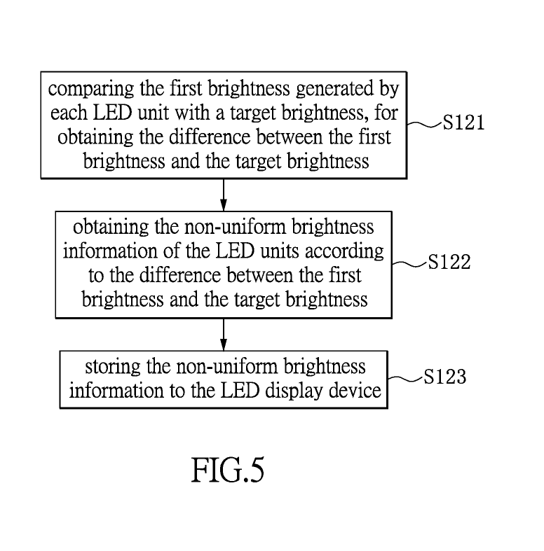

The brightness information generating device 3 has computing and processing power, and the brightness information generating device 3 can generate a non-uniform brightness information NH according to the detection results of the brightness detection device 2. Details of generating the non-uniform brightness information NH will be described in FIG. 5 hereinafter. The storage unit 12 is used for coupling to the brightness information generating device 3, for receiving and storing the non-uniform brightness information NH from the brightness information generating device 3. In general, when the dot correction test process is completed, the storage unit 12 can disconnect with the brightness information generating device 3. That is, the storage unit 12 can decouple with the brightness information generating device 3 when the storage unit 12 has already received and stored the non-uniform brightness information NH from the brightness information generating device 3. At the point of a finished product, the brightness detection device 2 and the brightness information generating device 3 are unnecessary for the user when the user uses the LED display device 1. Also, the storage unit 12 can pre-store the non-uniform brightness information NH in a factory setting (or before shipment). The non-uniform brightness information NH is obtained when the LED display device 1 is in the factory (or before shipment), wherein the non-uniform brightness information NH is obtained by constituting a test system comprising the LED display device 1, the brightness information generating device 3 and the brightness detection device 2 for obtaining the dot correction information (which is the non-uniform brightness information NH).

It should be noted that, in practice, when considering the LED display device 1 as a product, the LED display device 1 does not have to comprise the brightness information generating device 3 and the brightness detection device 2. However, when considering the non-uniform brightness of the LED units 11 caused by long term use, the brightness detection device 2 and the brightness information generating device 3 can be selectively integrated into the LED display device 1. Thus, the user can manually control the LED display device 1 to enable the built-in the brightness detection device 2 and the brightness information generating device 3 to update the non-uniform brightness information NH. Alternatively, based on the programming design for the firmware, the non-uniform brightness information NH can be updated each time of starting up the LED display device 1. The brightness detection device 2 and the brightness information generating device 3 can be automatically enabled to update the non-uniform brightness information NH when the LED display device 1 starts up.

The driving circuit 13 is coupled to the plurality of LED units 11 and the storage unit 12. The driving circuit 13 respectively drives the plurality of LED units 11 to make the plurality of LED units 11 emit light. The driving circuit 13 respectively provides a driving current to each LED unit of the plurality of LED units. The driving circuit 13 adjusts the driving current provided to each LED unit according to the non-uniform brightness information NH in order to make the brightness of each LED unit be the same.

In other words, the driving circuit 13 can be used to implement the step S110 of FIG. 3. The step S130 of FIG. 3 uses the brightness detection device 2 to detect the brightness of each LED unit 11 of the LED units 11 arranged in an array, and transmits the sensed brightness signal to the brightness information generating device 3 for generating the non-uniform brightness information NH. As for the step S130 of FIG. 3, after the storage unit 12 receives and stores the non-uniform brightness information NH, the storage unit 12 transmits the non-uniform brightness information NH to the driving circuit 13, then the driving circuit 13 adjusts the driving current I according to the non-uniform brightness information NH, in order to make the brightness of each LED unit be the same. In short, the non-uniform brightness information NH is used to generate a current adjustment value ΔI corresponding to the driving current of each LED unit, accordingly the driving circuit 13 can generate the adjusted driving current (I+ΔI) corresponding to each LED unit.

Please refer to FIG. 3 in conjunction with FIG. 4 and FIG. 5. FIG. 5 is a detailed flow chart of the step S120 in FIG. 3. In step S121, comparing the first brightness generated by each LED unit with a target brightness (or a predetermined brightness), for obtaining the difference between the first brightness and the target brightness. The step S121 can be achieved by the brightness information generating device 3. The brightness information generating device 3 can be a computer or other type of computing platform, but the instant disclosure is not so restricted. In detail, when the LED units in each column (or each row) are driven, the brightness detection device 2 respectively detects the brightness (which is the first brightness) of each LED unit in the same column (or the same row). The first brightness corresponding to each LED unit in the same column (or the same row) can be compared with preset target brightness. Accordingly, the difference between the first brightness of each LED unit in the column (or the row) and the target brightness can be obtained. Due to manufacturing process factors, each LED may generate different brightness even if driven by the same driving current. Therefore, as for the LED display device 1, it is possible to find out at least one (or more than one) LED unit providing brightness different from the brightness of other LED units. Then, in the same way, the driving circuit 13 can drive LED units in other columns (or other rows), for obtaining the difference between the first brightness of each LED unit in other columns (or other rows) and the target brightness.

Then, in step S122, obtaining the non-uniform brightness information NH of the LED units according to the difference between the first brightness and the target brightness. The mentioned non-uniform brightness information NH comprises the difference between the first brightness of each LED unit and the target brightness.

Then, in step S123, storing the non-uniform brightness information NH to the LED display device. For example, storing the non-uniform brightness information NH to the storage unit 12 of the LED display device 1. After the step S123 is completed, executing the step S130 of FIG. 3. At the same time, if the LED display device 1 has to display the target brightness, the driving circuit 13 can adjust the driving current according to the non-uniform brightness information NH, in order to make each LED unit able to generate the same target brightness. In detail, when the first brightness of the LED unit is higher than the target brightness, the non-uniform brightness information NH correspondingly can cause the driving current of the driving circuit 13 to decrease (that is the current adjustment value ΔI is negative). Thus, the adjusted driving current (I+ΔI) would be less than the original driving current I. Otherwise, when the first brightness of the LED unit is lower than the target brightness, the non-uniform brightness information NH correspondingly can cause the driving current of the driving circuit 13 to increase (that is the current adjustment value ΔI is positive). Thus, the adjusted driving current (I+ΔI) would be larger than the original driving current I. Accordingly, in the condition of the driving circuit 13 using the adjusted driving current (I+ΔI) to drive the corresponding LED unit, the brightness detection device 2 should detect that the brightness of all LED units are the same. Accordingly, it can be observed the dot correction for the LED display device 1 has been achieved.

According to above descriptions, the provided dot correction method and system for an LED display device can scan the non-uniform brightness of the LEDs of each column or each row, and store the non-uniform brightness information NH of the LEDs in each column or each row. Then, when the LED display device is starting up, the dot correction method can adjust the driving current for the LEDs in each column or each row according to the non-uniform brightness information, without using the conventional compensation bits of the control bits in the pulse width modulation signal. For achieving the correction purpose (or efficacy), the manufacturer only has to pre-store the non-uniform brightness information NH generated by testing process to the storage unit of the LED display device at the factory or before shipment. Accordingly, the dot correction circuit used in the LED display device can be simplified, and the related cost of the circuit can be reduced.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A dot correction method for an LED display device, used for the LED display device, the LED display device having a plurality of LED units arranged in an array, the method comprising:
providing driving currents to the plurality of LED units in columns or rows of the LED display device to make the LED units emit light;
obtaining a non-uniform brightness information corresponding to the LED units in columns or rows of the LED display device, wherein comparing a first brightness generated by each LED unit with a target brightness, for obtaining the difference between the first brightness and the target brightness, obtaining the non-uniform brightness information of the LED units according to the difference between the first brightness and the target brightness, and storing the non-uniform brightness information to a storage unit of the LED display device; and
adjusting the driving current provided to each LED unit according to the non-uniform brightness information, in order to make the brightness of each LED unit be the same.

2. The dot correction method for the LED display device according to claim 1, wherein in the step of adjusting the driving current provided to each LED unit according to the non-uniform brightness information in order to make the brightness of each LED unit be the same, the non-uniform brightness information corresponds to a current adjustment value of the driving current for each LED unit.

3. The dot correction method for the LED display device according to claim 1, wherein the first brightness is detected by a brightness detection device, the non-uniform brightness information is generated by a brightness information generating device.

4. A dot correction system for a LED display device, comprising:
a brightness detection device;
a brightness information generating device, coupled to the brightness detection device, used for generating a non-uniform brightness information; and
an LED display device, comprising:
a plurality of LED units arranged in an array, wherein the brightness detection device detects the brightness of the plurality of LED units;
a storage unit, used for coupling to the brightness information generating device, for receiving and storing the non-uniform brightness information from the brightness information generating device; and
a driving circuit, coupled to the plurality of LED units and the storage unit, respectively driving the plurality of LED units to make the plurality of LED units emit light, wherein the driving circuit respectively provides a driving current to each LED unit of the plurality of LED units, the driving circuit adjusts the driving current provided to each LED unit according to the non-uniform brightness information in order to make the brightness of each LED unit be the same.

5. The dot correction system for the LED display device according to claim 4, wherein when the driving circuit respectively provides a driving current to each LED unit of the plurality of LED units, each LED unit generates a first brightness, the brightness detection device compares the first brightness generated by each LED unit with a target brightness for obtaining the difference between the first brightness and the target brightness, the brightness information generating device obtains the non-uniform brightness information of the LED units according to the difference between the first brightness and the target brightness.

6. The dot correction system for the LED display device according to claim 4, wherein the non-uniform brightness information corresponds to a current adjustment value of the driving current for each LED unit.

7. An LED display, comprising:
a plurality LED units arranged in an array;
a storage unit, used for storing a non-uniform brightness information; and
a driving circuit, coupled to the plurality of LED units and the storage unit, respectively driving the plurality of LED units to make the plurality of LED units emit light, wherein the driving circuit respectively provides a driving current to each LED unit of the plurality of LED units, the driving circuit adjusts the driving current provided to each LED unit according to the non-uniform brightness information in order to make the brightness of each LED unit be the same;
wherein the non-uniform brightness information is obtained by calculations of a brightness information generating device coupled to a brightness detection device after the brightness detection device detecting the brightness of the plurality of LED units.
